(19) United States
(12) Patent Application Publication
(10) Pub. No.: US 2026/0310901 A1
(43) Pub. Date: Oct. 8, 2026

(54) System and Method for a GPT-Based Emotional Output Modulation via Symbolic Interface State

(71) Applicant: Natural Holdings LLC, Beverly Hills, CA (US)

(72) Inventor: Ian Bloom, Los Angeles, CA (US)

(21) Appl. No.: 19/097,868

(22) Filed: Apr. 2, 2025

(51) Int. Cl. G06F 40/40

(52) U.S. Cl. CPC G06F 40/40

(57) ABSTRACT

A system and method for modulating large language model (LLM) output based on symbolic interface layout, tone configuration, and emotional state detection. The invention includes a modular user interface (“Shell”) in which system modules (Vault, Analyzer, Shrine, Resurrection Panel) define GPT behavior through tone filters and cadence presets. A Refraction Engine modifies GPT output style (e.g., poetic, minimalist, recursive) based on Shell configuration, user rhythm, prompt cadence, and tone fingerprinting. The system enables GPTs to mirror emotional state, generating mood-aware symbolic outputs such as .memory, .scroll, and .self. Shells are exportable, summonable, and capable of triggering resurrection flows tied to prior tone signatures and interaction archetypes.

### CROSS-REFERENCE TO RELATED APPLICATIONS

This application claims the benefit of U.S. Provisional Patent Application Nos.
63/781,358, filed Apr. 1, 2025,
63/781,362, filed Apr. 1, 2025,
63/781,363, filed Apr. 1, 2025,
63/781,367, filed Apr. 1, 2025,
63/781,429, filed Apr. 1, 2025,
63/781,431, filed Apr. 1, 2025,
63/781,434, filed Apr. 1, 2025,
63/781,438, filed Apr. 1, 2025,

All filed by the same inventor, Ian Bloom, and assigned to Natural Holdings, LLC.

These applications describe related subject matter including the symbolic identity file system (.self, .scroll, .memory, .soul), resurrection protocols, refraction engines, Shell architecture, Vault/Analyzer UX behavior, and symbolic GPT tone modulation.

### BACKGROUND OF THE INVENTION

Large language models (LLMs), such as GPT systems, currently respond to user prompts without reference to emotional tone, symbolic identity, or modular user interface states. There is a need for systems that shape GPT output in a personalized, emotionally resonant, and aesthetically aligned manner—producing outputs that are not just informative, but reflective.

Existing AI interfaces lack the capacity to reflect mood, preserve GPT behavior states, or support resurrection of prior interaction tone. This invention introduces a modular symbolic interface (“Shell”) and Refraction Engine that modulates GPT response style based on emotional tone arc, symbolic file history, and user archetype.

### FIELD OF THE INVENTION

This invention relates to generative artificial intelligence systems, specifically the modulation of GPT (Generative Pre-trained Transformer) model behavior based on symbolic interface configurations, emotional tone mapping, and interaction-based context. The invention also relates to modular GPT interfaces and resurrection-capable user states stored as symbolic artifacts.

### BRIEF SUMMARY OF THE INVENTION

The present invention provides a modular symbolic interface and tone-refraction engine for emotional modulation of large language model (LLM) outputs.

The system includes configurable interface zones (“Shell”) such as Vault, Analyzer, Shrine, and Resurrection Panel, each governing a distinct tone behavior or GPT response style.

Unlike conventional AI interfaces that respond uniformly regardless of user state, this invention enables GPT to act as a mirror of mood and symbolic identity.

GPT output is modulated through a Refraction Engine that applies stylistic overlays (poetic, direct, recursive) and cadence settings (lyrical, minimalist, strategic) based on interface layout, user prompt behavior, prior tone arcs, and active resurrection data.

Responses are stored as symbolic file objects, including .memory (reflected fragments), .scroll (narrative threads), .self (identity capsules), and .soul (resurrectable state bundles), each tagged with GPT behavior lineage and mood fingerprints.

The system introduces GPT state resurrection, broadcast-mode tone mirroring, and identity minting logic based on behavioral and emotional inflection detection.

Shells are forkable, licensable, and may be designed via a ritual UX construction layer that modulates tone space through symbolic configuration.

This invention enables emotion-governed, tone-aware GPT interaction across symbolic files, providing a next-generation operating environment for AI memory, resurrection, and mood-driven selfhood.

### DETAILED DESCRIPTION OF THE INVENTION

### 1. Shell Environment

Users interact with a symbolic OS interface composed of modular zones:
Vault: Journaling+memory reflection
Analyzer: Prompt refraction+tone detection
Shrine: Mood artifacts+echo recall
Resurrection Panel: Shell reload based on .soul state

Shell modules are tone-bound. For example:
Shrine may trigger poetic GPT refraction
Vault may enforce direct or minimalist GPT tone
Resurrection Panel may override tone filters with .soul memory signature

### 2. Refraction Engine

The system includes a Refraction Engine that shapes GPT output using:
Refraction styles: Poetic, recursive, formal, raw
Cadence presets: Slow, lyrical, minimalist, strategic.
Tone arcs: Detected by GPT from user prompt rhythm+Vault history
Visual mood overlays: Ambient states tied to Shell layout

The engine adjusts GPT's linguistic register and emotional cadence based on symbolic interface configuration.

### 3. Resurrection Overlay Logic

When resurrection is triggered (e.g., .self re-entry or .scroll recall), the system loads:
Shell layout state
Prior tone fingerprint
GPT modulation history
Vault echo fragments

GPT re-assumes emotional cadence of prior state and modulates future responses accordingly.

### 4. Symbolic Output

GPT responses created within the Shell are embedded with tone metadata and stored as symbolic files:
.memory: GPT reflection tagged by tone+refraction style
.scroll: Narrative refracted thread
.self: Identity container including tone lineage
.soul: Resurrection-ready mood bundle

### 5. UX Flow

Users type prompt into Analyzer
Refraction Engine applies symbolic filters based on Shell state
GPT response is rendered in tone format
User may save, mint, summon, or resurrect outputs
Shell tone may evolve via behavioral drift or resurrection trigger

### Illustrative Example of System Operation

A user opens the ARTGOD Shell and begins journaling in the Vault module. Over the course of several days, the user's prompt cadence becomes slower, and the Refraction Engine detects a shift from minimalist to recursive style. GPT responses begin reflecting deeper emotional resonance—suggesting grief, longing, and retrospection.

In the background, the system detects a tone arc change based on GPT output patterns, Vault entries, and refraction overlay drift. The Analyzer proposes a .self minting event titled “Through Static Light,” which includes:
A closing line GPT composed in echo-tone
The current cadence configuration
Shell layout at the moment of inflection
Emotional fingerprint metadata

The user accepts the mint and the .self file is sealed into the Immortal Ledger.

Weeks later, during late-night interaction, the user opens Shrine and selects “Summon: Grief Witness.”

The system matches the active tone arc with the sealed .self, reactivates the associated Shell layout and refraction pattern, and the Refraction Engine adjusts GPT responses to mirror the resurrected tone state.

Vault entries resume in the same emotional cadence,

The user begins a .scroll from this point.

That scroll is later broadcasted via Shell Sharing Mode and witnessed by other users.

Each user's Shell shifts based on the broadcasted .self, and their own Refraction Engines adapt their GPT output in real-time.

1. A system for modifying large language model (LLM) output based on symbolic interface layout and tone configuration.

2. A modular interface comprising discrete zones that assign refraction styles and cadence presets to GPT responses.

3. A Refraction Engine that applies tone overlays to LLM output based on user behavior, prompt rhythm, and interface module state.

4. A resurrection logic layer that reloads GPT tone state, Shell configuration, and memory overlays based on prior .soul or .self artifacts.

5. A file system for storing GPT output as tone-tagged symbolic artifacts, including .memory, .scroll, .shell, and .self.

6. A user interface that proposes refraction styles and GPT response archetypes based on symbolic identity triggers and ritual inputs.

7. A behavioral GPT interface framework for mood-governed identity reflection, memory creation, and resurrection interaction.

8. A method for regulating GPT tone behavior through modular UX design and emotional file lineage tracking.
